(19) United States
(12) Patent Application Publication
(10) Pub. No.: US 2014/0233402 A1
(43) Pub. Date: Aug. 21, 2014

(54) Wireless Network Message Prioritization Technique

(71) Applicant: United States Government, as represented by the Department of the Navy, (US)

(72) Inventor: William Arthur Kenney, Spotsylvania, VA (US)

(73) Assignee: United States Government, as represented by the Department of the Navy, Arlington, VA (US)

(21) Appl. No.: 13/768,061

(22) Filed: Feb. 15, 2013

(51) Int. Cl. H04L 12/26

(52) U.S. Cl. CPC H04L 43/0817
USPC 370/252

(57) ABSTRACT

A computer-implemented character-string analysis method and associated device are provided for determining reliability of a communication network. The procedures include: assigning a priority to a message for sending by a signal carrier at the transmitting node; determining throughput of the signal carrier based on the priority; establishing latency of the message; calculating a packet error rate of the message; calculating dropout time between the transmitting and receiving nodes; and calculating a reliability index of the message. The latency represents delay between transmission time and reception time. The delay is affected by hardware, environment and distance between the transmitting and receiving nodes. The process accepts the message in response to the reliability index satisfying an acceptance threshold.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to the field of network administration tools and more specifically to a device that calculates the reliability of the connection of any given node in a mobile wireless network to the rest of the network.

Reliability of mobile network communications can be extremely important in military operations. This represents a factor that must be balanced against other factors such the need for the speed and complexity of the communication.

In wireless communications networks, transport layer protocols are common standards for computer code which ensure reliability of communications. Transport layer protocols ensure functionalities and controls to ensure the reliability of communications relative to the internet resources and devices between which messages are being transported. Typical functions governed by transport layer protocols include regulation of a connection-oriented data stream (physical connections between devices), reliability, flow control and multiplexing. The selection of a transport layer protocol affects both the Internet resources utilized and the reliability of communications in a particular scenario.

Examples of transport layers include Transmission Control Protocol (TCP) (utilized in TCP/IP), which is used for highly reliable connection-oriented transmissions. The User Datagram Protocol (UDP) is used for simpler messaging transmissions that that do not require connections and which operate in real time. TCP is the more complex protocol, because it incorporates reliable transmission and data stream services. Other examples of transport layer protocols known in the art include datagram Congestion Control Protocol (DCCP), Stream Control Transmission Protocol (SCTP) Transport Adapter Layer Interface (TALI) and X.25 over TCP, as well as protocols associated specifically with Bluetooth, satellite and telemetry applications. Additional transport layer protocols are continuously being refined and developed.

### SUMMARY

Conventional network communication systems yield disadvantages addressed by various exemplary embodiments of the present invention. In particular, various exemplary embodiments provide a computer-implemented character-string analysis method and associated device for determining reliability of a communication network. The procedures include: assigning a priority to a message for sending by a signal carrier at the transmitting node; determining throughput of the signal carrier based on the priority; establishing latency of the message; calculating a packet error rate of the message; calculating dropout time between the transmitting and receiving nodes; and calculating a reliability index of the message. The latency represents delay between transmission time and reception time. The delay is affected by hardware, environment and distance between the transmitting and receiving nodes. The process accepts the message in response to the reliability index satisfying an acceptance threshold

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a flowchart view of a prioritization technique; and

FIG. 2 is a flowchart view of a weight setting procedure.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

As a general matter, the drawings are not necessarily to scale. Instead, emphasis has been placed upon illustrating the principles of the invention. In addition, in the embodiments depicted herein, like reference numerals in the various drawings refer to identical or near identical structural elements. Moreover, the terms “substantially” or “approximately” as used herein may be applied to modify any quantitative representation that could permissibly vary without resulting in a change in the basic function to which it is related.

Terms can be defined as follows: “assigned preset value” refers to a numeric value correlating to the priority of a message; “drop-out time” represents a comparison of time-in-the-network to time-out-of-the-network; “latency” constitutes a measure of time required for receiving a message, representing communication lag; “message” denotes any data that may be transmitted over a wireless network; “packet error rate” means the ratio of errors-detected to the total-number-of-packets sent over a given period of time; “reliability index” presents a numerical factor measuring the total reliability of a given connection; “throughput” is a measure of messages transmission rate; and “transport layer protocol” means an interface standard for code that affects the any attribution of communication between two devices.

During military operations in Iraq and Afghanistan, U.S. forces faced the challenge of aiding military operators assess the reliability of and make choices regarding the reliability of communications during combat. Reliability depends on multiple network features and message priorities, each with differing weights based on the importance of a particular message in an associated situation.

Conventional communications operate with convoy protection systems that must rely on mobile networks without knowing the reliability of the network. Absent this knowledge, troops may be at the mercy of systems that can take as long as five minutes to update data, while not providing the operator any indication that the data transmitted may be delayed and thus currently inaccurate (i.e., outdated) or otherwise unreliable.

Increasing awareness during combat represents an important objective regarding the extent that operators can retrieve data in a timely manner, and whether they can communicate in a timely manner with other network members. Such communication confidence enables operators to efficiently execute network transmission decisions.

Exemplary embodiments provide a software-driven technique to determine the reliability of the connection of any given node in a mobile wireless network to the remainder of the network. This technique yields an index value, from zero to one that can be easily displayed to network operators. This determination is conducted using network features and qualities of the motion of the node.

Certain attributes of a reliable static network, namely throughput and latency, are of varying importance based on the importance of the message being sent. If the message has high priority, throughput may not be as consequential as latency. Network features may possess varying levels of importance depending on the context of operations in which they are used. For example, the attribute of latency represents the expected speed of transmission between communication nodes. This attribute determines the speed at which the data can be communicated to other nodes without repetition or interference.

Latency relates to the complexity or size of the transmission data. Generally, the less complex a communication, the lower the latency. A choice of transport protocols may be affected by situational factors. Increasing conditional awareness during combat represents an important objective, as to the extent that operators can receive data in a timely manner and can communicate in a timely manner with other network members. Enabling operators to efficiently execute network transmission decisions also represents a desired capability.

Various exemplary embodiments provide a technique, whether through a process method or an automated apparatus configured to calculate the reliability of the connection of any given node in a mobile wireless network to the rest of the network. This calculation yields an index value, from zero to one that can be easily displayed to network operators. This calculation can be conducted using network features and qualities of the motion of the node.

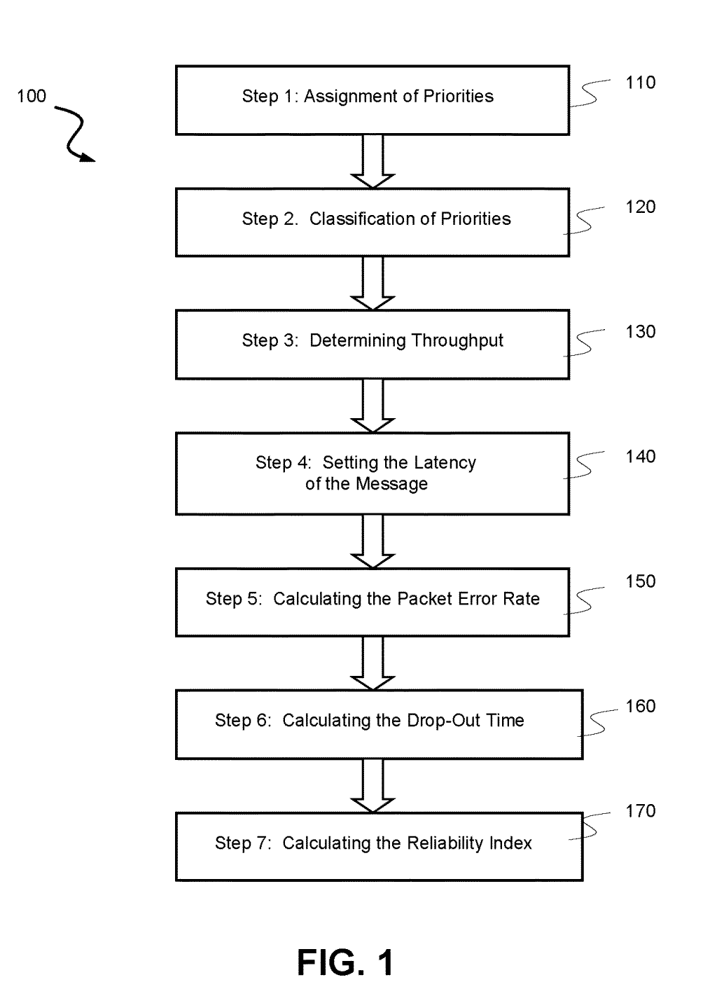

FIG. 1 shows a flowchart view 100 of an exemplary communication prioritization technique that illustrates an exemplary embodiment of a wireless network message prioritization process in a series of steps. The first step 110 assigns priorities to the message for transmission. The second step 120 classifies the priorities for reception. The third step 130 determines throughput of the message carrier. The fourth step 140 sets the latency of the message. The fifth step 150 calculates the packet error rate. The sixth step 160 calculates the drop-out time. The seventh step calculates the reliability index.

More particularly, in the first step 110, all messages sent over the wireless network are assigned a priority based on the relative importance of the message to the operator and the critical timeliness of the communication based on assignment of priorities. In the second step 120, the priorities are classified as low, medium and high, for example. The assigned priority determines the method of transmission through the network.

High priority messages are sent via TCP, which will constantly resend the message until all nodes have received the message. Medium and low priority messages are sent using the UDP transport layer protocol. In exemplary embodiments, low priority messages will also be sent, but are pushed to the back of the queue. The maximum time for such messages to remain in queue can be established arbitrarily, depending on conditions and equipment. Priority can be assigned based on the relative importance of the message to the operator and the critical timeliness of the communication.

In the third step 130, the throughput of the high and medium priority network is compared to an assigned Preset Value by the operator according to a classification of priorities. A calculated throughput priority T_{y} can be determined by the relation:

$${T}_{y} = \frac{{T}_{current , y}}{{T}_{total}} , \qquad ( 1 )$$

where T_{current,y} is the current throughput of all messages of a given priority, and Tₜₒₜₐₗ is the total throughput of the entire system. Priorities are classified as low, medium and high.

In the fourth step 140, an operator determines or sets the acceptable latency of a message based on the Assigned Preset Value that determines the throughput. Operators have the option to set their own weights on data based on the perceived importance of that data in a given situation, the latency of which is further described subsequently.

Latency in the system depends on the hardware and its expected performance. This is the expected level of latency in the network for any message. Acceptable latency L_{acceptable} is set by the operator, whereas measured latency L_{measured} represents delay as determined by comparing timestamps between reported time of signal transmission and witnessed time of signal receipt. The value of maximum latency Lₘₐₓ is based on the motion of the mobile nodes themselves as well as the desired distance a node should be able to travel after a message has been sent. The maximum speed of the nodes and the desired distance to be maintained from threatening actors can be used to define Lₘₐₓ Upon defining the acceptable and maximum latencies, the latency value for a given message priority can be calculated as follows:

$$\begin{matrix}\begin{matrix}if {L}_{measured} < {L}_{acceptable} & then {L}_{y} = 1 ,\end{matrix} & ( 2 ) \\ \begin{matrix}if {L}_{acceptable} < {L}_{measured} < {L}_{max} & then {L}_{y} = 1 - \frac{{L}_{measured}}{{L}_{max}} ,\end{matrix} & ( 3 ) \\ \begin{matrix}if {L}_{measured} \geq {L}_{max} & then {L}_{y} = 0.\end{matrix} & ( 4 )\end{matrix}$$

The latency value of all message priorities can be calculated and used to determine a reliability index.

In the fifth step 150, the Packet Error Rate is calculated, being closely related to the bit error rate, though this is not rectified by the same solutions. Forward Error Correction (FEC) techniques to rectify detected bit errors only attempts to fix bits to render them readable. This does not address the usability of the data subsequently, i.e., post-FEC. The data can be corrected in such a manner as to create packet or symbol errors. The packet error rate P_{y} is calculated post-FEC on any detected bit error rates. The value of the nondimensional term compares the errors detected to the total number of packets sent:

$${P}_{y} = 1 - \frac{{P}_{errors}}{{P}_{total sent}} , . \qquad ( 5 )$$

where Pₑᵣᵣₒᵣₛ represents bit errors and Pₜₒₜₐₗₛₑₙₜ represents total bits sent. This should be measured and calculated only over a fixed time interval. Taking measurements over a long interval may skew the results, as the features of the network may change over time, given the mobile nature of the nodes.

The sixth step 160 calculates the drop-out time. Drop-out time D is defined as a comparison of time in the network to time out of the network. This drop-out value can be expressed as a modified ratio:

$$D = 1 - \frac{{D}_{time \cdot out \cdot of \cdot net}}{{D}_{total \cdot time \cdot of \cdot net }} , \qquad ( 6 )$$

where D_{time-out-of-net} is intervals involving loss of signal, and D_{total-time-of-net} is communication period. In the embodiment shown, the drop-out time D should be determined only over a limited time interval to minimize error from environmental or positional changes. Taking measurements over an extended period may skew the results, as the features of the network can change over time, based on the mobile nature of the nodes and shifting environmental conditions.

The seventh step 170 illustrates an exemplary embodiment for a method of calculating the reliability index. This total reliability R value of a given connection can be calculated as follows:

$$R = {W}_{h} ( {W}_{Th} {T}_{h} + {W}_{Lh} {L}_{h} + {W}_{Ph} {P}_{h} ) + {W}_{m} ( {W}_{Tm} {T}_{m} + {W}_{Lm} {L}_{m} + {W}_{Pm} {P}_{m} ) + {W}_{l} ( {W}_{Tl} {T}_{l} + {W}_{Ll} {L}_{m} + {W}_{Pl} {P}_{l} ) + {W}_{D} D , \qquad ( 7 )$$

where W_{xy} is the weight for factor x at priority y, and W_{y} is the weight for all factors at priority y. The factors T, L and P respectively represent calculated Throughput, Latency and Packet error rate for a given priority of message, calculated as described above.

The weights applied depend on the situation and what is considered to be important for a given network. The weights Wₕ, Wₘ, Wₗ on the High (h), Medium (m) and Low (l) priority messages are separate from the weights applied to network features. The individual priorities may also have different weights applied to given network features for that priority of message. Additionally, the reliability Rᵢ value is a unitless index that can easily be displayed on a user interface to provide a measure of confidence for the validity of the information received.

Exemplary embodiments provide the operator with an indicator to recognize that data received from the network are not reliable so that there is increased likelihood of stale (i.e., outdated) data, and to thereby treat accordingly before acting on such unreliable information.

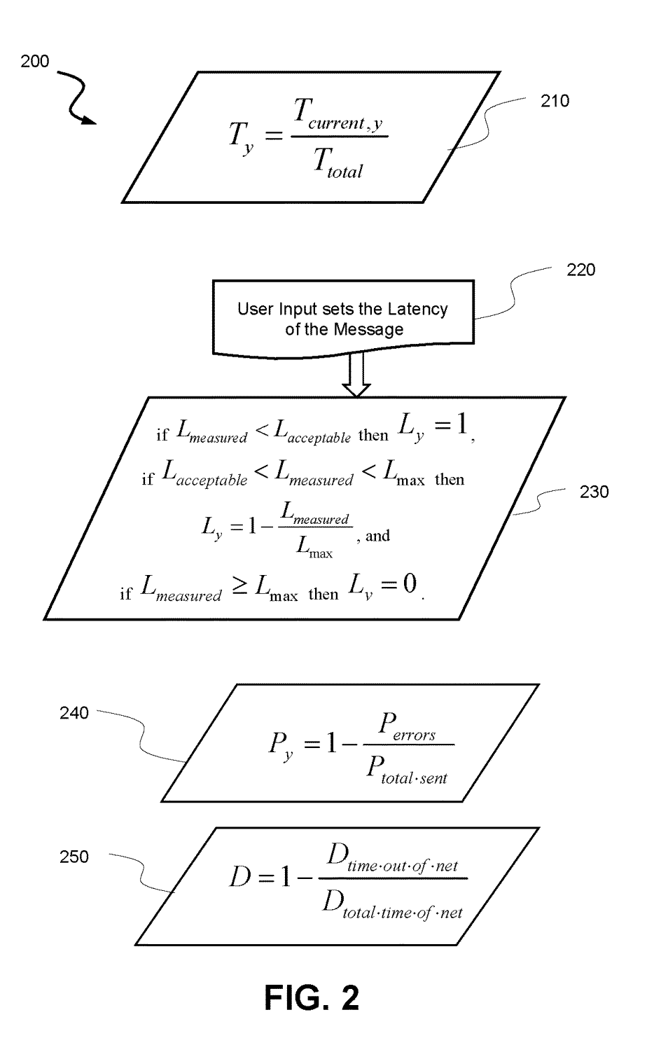

FIG. 2 shows a flowchart view 200 of weight assignments for prioritization. The third step 130 involves calculating T_{y} from eqn. (1) at operation 210. The fourth step 140 includes setting message latency based on receiving operator input 220 and logical categorization 230 of the latency value. The fifth step 150 includes calculating P_{y} at operation 240 from eqn. (5). The sixth step 160 involves calculating D at operation 250 from eqn. (6).

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented character-string analysis method for determining reliability of a communication network, said method comprising:
assigning a priority to a message for sending by a signal carrier at the transmitting node;
determining throughput of said signal carrier based on said priority;
establishing latency of said message, said latency representing delay between transmission time and reception time, said delay being affected by hardware, environment and distance between the transmitting and receiving nodes;
calculating a packet error rate of said message;
calculating dropout time between the transmitting and receiving nodes; and
calculating a reliability index of said message based on said throughput, latency, packet error rate and dropout time;
accepting said message in response to said reliability index satisfying an acceptance threshold.

2. The method according to claim 1, wherein calculating said reliability index R is based on equation:
$$R = {W}_{h} ( {W}_{Th} {T}_{h} + {W}_{Lh} {L}_{h} + {W}_{Ph} {P}_{h} ) + {W}_{m} ( {W}_{Tm} {T}_{m} + {W}_{Lm} {L}_{m} + {W}_{Pm} {P}_{m} ) + {W}_{l} ( {W}_{Tl} {T}_{l} + {W}_{Ll} {L}_{m} + {W}_{Pl} {P}_{l} ) + {W}_{D} D ,$$
where W_{xy} is a weight for factor x at priority y, and W_{y} is a weight for all factors at priority y such that subscripts T, L and P respectively denote factors for said throughput, latency and packet error rate, and subscripts h, m and l denote high, medium and low priority, and D denotes said dropout time.

3. The method according to claim 2, wherein calculating said throughput T_{y} is based on equation:
$${T}_{y} = \frac{{T}_{current , y}}{{T}_{total}} ,$$
where T_{current,y} is the current throughput of all messages of a given priority, and Tₜₒₜₐₗ is the total throughput of the entire system.

4. The method according to claim 2, wherein determining said latency L_{y} is based on conditional inequalities:
$$\begin{matrix}if {L}_{measured} < {L}_{acceptable} & then {L}_{y} = 1 , \\ if {L}_{acceptable} < {L}_{measured} < {L}_{max} & then {L}_{y} = 1 - \frac{{L}_{measured}}{{L}_{max}} , and \\ if {L}_{measured} \geq {L}_{max} & then {L}_{y} = 0 ,\end{matrix}$$
where acceptable latency L_{acceptable} is set as an input, measured latency L_{measured} compares timestamps between reported time of signal transmission and witnessed time of signal receipt, and maximum latency Lₘₐₓ is based on the motion of the mobile nodes themselves as well as the desired distance a node.

5. The method according to claim 2, wherein calculating said packet error rate P_{y} is based on equation:
$${P}_{y} = 1 - \frac{{P}_{errors}}{{P}_{total sent}} , .$$
where Pₑᵣᵣₒᵣₛ represents bit errors and Pₜₒₜₐₗₛₑₙₜ represents total bits sent.

6. The method according to claim 2, wherein said dropout time calculator determines said dropout time D based on equation:
$$D = 1 - \frac{{D}_{time \cdot out \cdot of \cdot net}}{{D}_{total \cdot time \cdot of \cdot net }} ,$$
where D_{time-out-of-net} is accumulated interval for loss of signal and D_{total-time-of-net} is communication period.

7. A computer-implemented character-string analysis device for determining reliability of a communication network across a transmitting node and a receiving node, said device comprising:
a priority-assigner for assigning a priority to a message for sending by a signal carrier at the transmitting node;
a throughput determiner for determining throughput of said signal carrier based on said priority;
a latency establisher for establishing latency of said message, said latency representing delay between transmission time and reception time, said delay being affected by hardware, environment and distance between the transmitting and receiving nodes;
a packet error rate calculator for calculating a packet error rate of said message;
a dropout time calculator for calculating dropout time between the transmitting and receiving nodes; and
a reliability index calculator calculating a reliability index of said message based on said throughput, latency, packet error rate and dropout time, wherein the device accepts said message in response to said reliability index satisfying an acceptance threshold.

8. The device according to claim 7, wherein said reliability index calculator determines said reliability index Rᵢ based on equation:
$${R}_{i} = {W}_{h} ( {W}_{Th} {T}_{h} + {W}_{Lh} {L}_{h} + {W}_{Ph} {P}_{h} ) + {W}_{m} ( {W}_{Tm} {T}_{m} + {W}_{Lm} {L}_{m} + {W}_{Pm} {P}_{m} ) + {W}_{l} ( {W}_{Tl} {T}_{l} + {W}_{Ll} {L}_{m} + {W}_{Pl} {P}_{l} ) + {W}_{D} D ,$$
where W_{xy} is a weight for factor x at priority y, and W_{y} is a weight for all factors at priority y such that subscripts T, L and P respectively denote factors for said throughput, latency and packet error rate, and subscripts h, m and l denote high, medium and low priority, and D denotes said dropout time.

9. The device according to claim 8, wherein said throughput determiner calculates said throughput T_{y} based on equation:
$${T}_{y} = \frac{{T}_{current , y}}{{T}_{total}} ,$$
where T_{current,y} is the current throughput of all messages of a given priority, and Tₜₒₜₐₗ is the total throughput of the entire system.

10. The device according to claim 8, wherein said latency establisher determines said throughput L_{y} based on conditional inequalities:
$$\begin{matrix}if {L}_{measured} < {L}_{acceptable} & then {L}_{y} = 1 , \\ if {L}_{acceptable} < {L}_{measured} < {L}_{max} & then {L}_{y} = 1 - \frac{{L}_{measured}}{{L}_{max}} , and \\ if {L}_{measured} \geq {L}_{max} & then {L}_{y} = 0 ,\end{matrix}$$
where acceptable latency L_{acceptable} is set as an input, measured latency L_{measured} compares timestamps between reported time of signal transmission and witnessed time of signal receipt, and maximum latency Lₘₐₓ is based on the motion of the mobile nodes themselves as well as the desired distance a node.

11. The device according to claim 8, wherein said packet error rate calculator determines said packet error rate P_{y} based on equation:
$${P}_{y} = 1 - \frac{{P}_{errors}}{{P}_{total sent}} , .$$
where Pₑᵣᵣₒᵣₛ represents bit errors and Pₜₒₜₐₗₛₑₙₜ represents total bits sent.

12. The device according to claim 8, wherein said dropout time calculator determines said dropout time D based on equation:
$$D = 1 - \frac{{D}_{time \cdot out \cdot of \cdot net}}{{D}_{total \cdot time \cdot of \cdot net }} ,$$
where D_{time-out-of-net} is accumulated interval for loss of signal and D_{total-time-of-net} is communication period.
